(19) United States
(12) Patent Application Publication
(10) Pub. No.: US 2003/0054920 A1
(43) Pub. Date: Mar. 20, 2003

(54) Method of controlling a transmission

(75) Inventors: Reinhard Berger, Buhl (DE); Gunter Hirt, Kongsberg (NO); Jurgen Benz, Oberkirch (DE)

Correspondence Address: DARBY & DARBY P.C., Post Office Box 5257, New York, NY, 10150-5257, US

(73) Assignee: LuK Lamellen und Kupplungsbau Beteiligungs KG

(21) Appl. No.: 10/223,053

(22) Filed: Aug. 15, 2002

Related U.S. Application Data
(63) Continuation of application No. PCT/DE01/00181, filed on Jan. 16, 2001.

(30) Foreign Application Priority Data
Feb. 15, 2000 (DE) 100 06 802.2
Mar. 29, 2000 (DE) 100 15 718.1

(51) Int. Cl. B60K 41/28; B60K 41/02

(52) U.S. Cl. 477/70; 477/109

(57) ABSTRACT

In a method of shifting a vehicle transmission from an old ratio to a new ratio, the output torque of the transmission is managed by controlling the engine torque and/or the transmittable torque of the main clutch, and by also controlling the transmittable torque of at least one of the gear-shifting clutches of the transmission.

### BACKGROUND OF THE INVENT

The present invention relates to a method of controlling a gear change in a transmission, and it also relates to a transmission that is operable to perform the inventive method.

Motor vehicle transmissions for adapting the engine speed to the vehicle speed have long been known. In particular, there are two distinct categories of gear-shifting transmissions, i.e., those in which a shift from one transmission ratio to another is accompanied by an interruption in vehicle traction and those that shift without an interruption in vehicle traction. It has proven advantageous to arrange a start-up clutch at the input side of gear-shifting transmissions, so that the flow of torque in the power train can be opened or closed as needed.

The present invention relates in particular to transmissions that work without an interruption in the tractive force and that are equipped with a start-up clutch on the input side as well as at least one gear-shifting clutch that can be engaged and disengaged under power, or at least one power-shift clutch. Transmissions of this type are disclosed, e.g., in DE 198 59 458 and in the earlier DE 199 45 473. The contents of both are hereby incorporated by reference in the present disclosure.

Transmissions that are capable of transmitting torque during a gear shift also include those in which substantially each of the gear-shifting clutches for shifting the individual gears can be shifted under power and in which the actuation or shifting of the transmission ratios may for example be automated so that they can be actuated or shifted at least substantially independent of each other.

In transmissions that can be shifted under power, it is of critical importance for the torque to be reduced before a gear shift, in order to give the driver the perception of a smooth, comfortable gear change. If there is an undesirable mismatch in the amounts of torque transmitted through the start-up clutch and/or gear-shifting clutch, the shifting can be perceived as very abrupt and uncomfortable.

### OBJECT OF THE INVENTION

It is therefore the object of the present invention to propose a method of controlling a gear change in a transmission, so that the gear-changing process is performed with comfort, speed and ease.

As a further objective, the present invention aims to provide a transmission that is operable to perform the inventive method.

### SUMMARY OF THE INVENTION

According to the invention, the foregoing objective is achieved by the concept that the drive torque at the output of the transmission is managed by controlling the torque supplied by the engine and/or the torque passed on through the clutch to the transmission as well as by controlling the amount of torque that can be transmitted through a gear-shifting clutch.

In the foregoing control process, it is advantageous if the gear-shifting clutch that belongs to the currently used gear ratio (also referred to herein as the old ratio) remains engaged until the drive torque has been lowered.

It also serves the purpose of the invention if a gear-shifting clutch that belongs to another than the currently engaged gear is actuated in a controlled manner to assist in the lowering of the drive torque.

If a gear-shifting clutch that belongs to another than the currently engaged gear is moved into engagement according to a given torque profile, it is practical to control the engine torque and/or the transmittable torque of the start-up clutch to achieve a targeted time profile of lowering or raising the drive torque.

In the preceding embodiment of the inventive method, it is advantageous if the gear-shifting clutch that is moved into engagement is the gear-shifting clutch that belongs to the new gear ratio to be set in the transmission.

However, it can also be advantageous if the gear-shifting clutch that is moved into engagement is not the gear-shifting clutch that belongs to the new gear ratio to be set.

Under a further advantageous concept of the invention, a method of controlling a gear change is proposed for a transmission that is equipped with a start-up clutch and at least one gear-shifting clutch for engaging the gear stages in an arrangement where the engine torque is controllable by means of a control device and an actuator and the clutches are controllable by means of at least one further actuator. According to the aforementioned method, the process of changing gears is performed in several phases. In a first phase, the engine torque and the transmittable torque of the start-up clutch are lowered. In a second phase, the gear-shifting clutch of the new gear to be set is pushed toward engagement by the controlled application of an actuator force. Simultaneously in the second phase, the gear-shifting clutch sleeve of the current gear is pushed towards its neutral position. In a third phase, the current gear is taken out of engagement when the remaining torque in the gear-shifting clutch has fallen to a prescribed level; and in a fourth phase, the gear-shifting clutch of the new gear is moved into engagement.

It is of practical benefit to raise the transmittable torque of the start-up clutch during the fourth phase. According to a further embodiment of the invention, it is advantageous to raise the engine torque during the fourth phase.

It is further advantageous if the transmittable torque of the start-up clutch is increased at a faster rate than the engine torque.

Furthermore, it is advantageous if at the end of the third phase the rpm-rates for the new gear have been equalized, i.e., if the synchronization of the new gear is completed.

It is also advantageous if in the first phase the lowering of the transmittable clutch torque and engine torque occurs without putting the clutch into a slipping condition.

However, in another embodiment it can be advantageous if in the first phase the lowering of the transmittable clutch torque and engine torque occurs with the clutch in a slipping condition.

Under a further advantageous concept of the invention, a method of controlling a gear change is proposed for a transmission that is equipped with a start-up clutch and at least one gear-shifting clutch for engaging the gear stages in an arrangement where the engine torque is controllable by means of a control device and an actuator and the clutches are controllable by means of at least one further actuator. According to the aforementioned method, the object of the invention is achieved by determining a torque differential representing the difference between the respective amounts of transmittable torque of the start-up clutch and a gear-shifting clutch of the new gear based on a specific amount of acceleration of the transmission input shaft.

When applying the foregoing concept, it is practical if the transmittable torque of the gear-shifting clutch M_{SK} is determined from the transmission input rpm-rate and the transmittable torque M_{AK} of the start-up clutch.

It is further of practical advantage to determine an rpm-rate differential Δn_{SK} for the gear-shifting clutch based on the transmission input rpm-rate and the transmission output rpm-rate.

Based on the aforementioned rpm-rate differential Δn_{SK}, it is further advantageous to determine the value of a function ΔM_{AK}=f(Δn_{SK}) indicating an amount ΔM_{AK} by which the transmittable torque of the start-up clutch is to be changed by the control device.

It is further of practical benefit if the transmittable torque M_{AK} of the start-up clutch is determined according to the equation M_{AK}=(M_{SK}/i)+ΔM_{AK}, where i stands for the new transmission ratio to be set in the gear change.

Under a further advantageous concept of the invention, a method of controlling a gear change is proposed for a transmission that is equipped with a start-up clutch and at least one gear-shifting clutch for engaging the gear stages in an arrangement where the engine torque is controllable by means of a control device and an actuator and the clutches are controllable by means of at least one further actuator. According to the aforementioned method, the process of synchronizing the transmission is performed in four steps. In a first step, the transmittable torque of the start-up clutch is lowered. In step two, a torque equilibrium is determined where the amounts of transmittable torque are equal in the start-up clutch and a gear-shifting clutch of the new gear to be engaged. In step three, the transmittable torque of the start-up clutch is lowered further until an inflection point is detected in the trend of the transmission input rpm-rate; and in step four, the transmittable torque of the start-up clutch is regulated to the level of the equilibrium torque.

It is advantageous if the amount of the equilibrium torque is determined at a point in time when the transmission input rpm-rate passes through a maximum or a minimum.

The novel features that are considered as characteristic of the invention are set forth in particular in the appended claims. The inventive method itself, however, together with additional features and advantages thereof, will be best understood upon perusal of the following detailed description of certain presently preferred specific embodiments with reference to the accompanying drawing.

### BRIEF DESCRIPTION OF THE DRAWINGS

The following detailed explanation of the invention is based on the attached drawings, wherein:

FIG. 1 represents a schematic view of a part of a transmission;

FIG. 2 represents a time graph to illustrate the time phases of a gear change;

FIG. 3 represents a flow chart for the control of a gear change;

FIGS. 4a, 4b, 4c represent time graphs;

FIGS. 5a, 5b represent time graphs;

FIG. 6 represents a flow chart for the control of a gear change;

FIG. 7 represents a schematic view of a part of a transmission;

FIGS. 8a, 8b represent time graphs;

FIG. 9 represents a time graph;

FIG. 10 represents a flow chart;

FIGS. 11a, 11b, 11c represent time graphs;

FIG. 12 represents a schematic view of a transmission; and

FIG. 13 represents a schematic view of a transmission.

### DESCRIPTION OF PREFERRED EMBODIMENTS

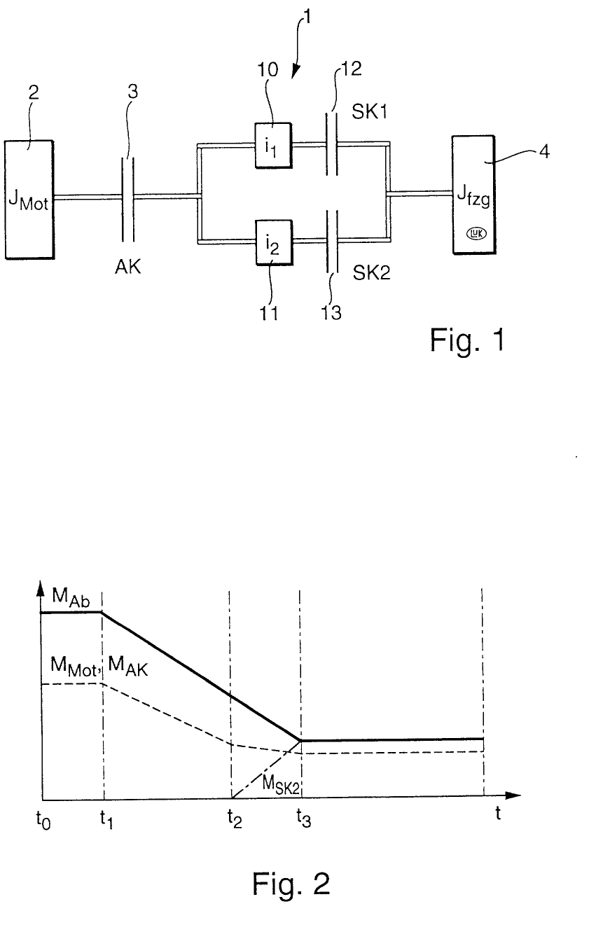

FIG. 1 schematically illustrates a part of a transmission 1 in the power train of a motor vehicle. The engine 2 is functionally represented by its mass moment of inertia Jₘₒₜ, and the down-stream part 4 of the power train after the transmission is functionally represented by the inertia of the vehicle expressed as a mass moment of inertia J_{fzg}.

The clutch 3 is configured as a start-up clutch AK between the engine 2 and the transmission 1.

The transmission includes among other elements two transmission stages 10 and 11 that are equipped with the two power-shiftable gear-shifting clutches 12 (SK1) and 13 (SK2). The transmission stages 10 and 11 have transmission ratios i₁ and i₂, respectively.

In performing a gear change in the presence of a torque load in a power-shift capable transmission 1, an essential aspect is the torque adaptation by lowering or raising the drive torque in the down-stream part 4 of the power train to the torque level of the power-shift clutch.

Following is the description of a strategy for lowering the drive torque according to a prescribed time profile for a transmission with two independent gear-shifting clutches. The time profile of the torque to be transmitted by the gear-shifting clutch is set as a given quantity. Depending on the operating state of the start-up clutch 3, i.e., whether it is fully engaged or slipping, the engine torque Mₘₒₜ or the transmittable torque M_{AK} of the start-up clutch is controlled in order to produce a drive torque of a desired magnitude.

The lowering of the drive torque M_{ab} in the beginning phase of a gear change is a characteristic trait in the time profile of a gear change with a torque load. The lowering of the drive torque can be achieved through the following factors:

1. The engine torque can be lowered through the setting of a target value in the control of the engine.

2. The magnitude of the transmittable torque of the start-up clutch AK can be lowered.

3. The drive torque can be lowered through an additional torque of a power-shift clutch SK.

A power-shifting transmission 2 with two independent gear-shifting clutches SK1 and SK2 according to FIG. 1 will serve to schematically describe an exemplary embodiment of the invention. During the lowering of the engine torque M_{Mot} and with the gear-shifting clutch SK1 engaged, an additional amount of torque is built up, i.e., transmitted, by the gear-shifting clutch SK2.

In the interest of a comfortable gear change, it is advantageous if the lowering of the drive torque M_{Ab} can be represented by a model. To keep heat accumulation in the gear-shifting clutch as low as possible, the transmission of torque through the gear-shifting clutch should not begin immediately with the lowering of the drive torque. Thus, it is advantageous if the drive torque can be tied to the engine torque and/or the start-up clutch torque and the shifting-clutch torque. For example, based on given time profiles of the drive torque and the shifting-clutch torque, the torque to be transmitted through the start-up clutch could be determined as the unknown quantity. A possible example for this concept is illustrated in FIG. 2, with a linear decrease of the drive torque M_{ab} and a linear increase of the shifting-clutch torque M_{SK2}. The engine torque Mₘₒₜ, or the transmittable torque M_{AK} of the start-up clutch if the latter is slipping, represents the determining factor for achieving the desired linear decrease of the drive torque M_{ab}.

FIG. 2 represents a time profile of the engine torque M_{Mot}, the drive torque M_{ab}, the torque M_{SK2} transmitted through the gear-shifting clutch S_{K2}, and the torque M_{AK} transmitted through the start-up clutch. In the time interval from t₀ to t₁, the drive torque and the engine torque are substantially constant. Subsequently, the drive torque is to be lowered in the time interval from t₁ to t₃.

FIG. 2 illustrates how, for example, the engine torque and/or the torque of the start-up clutch is lowered while the torque of the power-shiftable gear-shifting clutch SK2 is raised. In the illustrated case, the engine torque during the time interval from t₁ to t₂ is lowered at a different rate than during the time interval from t₂ to t₃ while at the same time in the interval from t₂ to t₃ the transmittable torque of the clutch SK2 is increased.

The torques that are relevant to the gear-changing process are related through the following equilibrium equations:

$${M}_{A K} = \frac{{M}_{S K1}}{{i}_{1}} + \frac{{M}_{S K2}}{{i}_{2}}$$

$${M}_{S K1} + {M}_{S K2} = {M}_{A B}$$

By algebraic manipulation, one obtains

$$( {M}_{A K} - \frac{{M}_{S K2}}{{i}_{2}} ) \cdot {i}_{1} + {M}_{S K2} = {M}_{A b} = {J}_{A b} \cdot {\ddot{ϕ}}_{A b} \\ {M}_{A K} = \frac{1}{{i}_{1}} [ {M}_{A b} - {M}_{S K2} ( 1 - \frac{{i}_{1}}{{i}_{2}} ) ] \qquad ( 1 )$$

The foregoing equation (1) holds true in general, regardless of whether the start-up clutch is in a locked or slipping condition. In the locked condition, the torque M_{AK} transmitted through the start-up clutch can be expressed by the equation:

M_{AK}=M_{Mot}−J_{Mot}·\ddot{φ}_{Mot}

If the gear-shifting clutch SK1 is assumed to remain engaged during the lowering of the torque, the transmission ratio i₁ can be expressed as

$${i}_{1} = \frac{{\ddot{ϕ}}_{M o t}}{{\ddot{ϕ}}_{A b}} ,$$

and thus the previous equation can be written as

M_{AK}=M_{Mot}−J_{Mot}·\ddot{φ}_{Ab}·i₁

By further algebraic manipulation of the foregoing equations, and assuming a locked engagement of the start-up clutch, one obtains:

$${M}_{M o t} \cdot {i}_{1} - {J}_{M o t} \cdot {\ddot{ϕ}}_{A b} \cdot {i}_{1}^{2} + {M}_{S K2} ( 1 - \frac{{i}_{1}}{{i}_{2}} ) = {J}_{A b} \cdot {\ddot{ϕ}}_{A b} \\ {M}_{M o t} = \frac{1}{{i}_{1}} [ ( \frac{{J}_{A b} + {J}_{M o t} \cdot {i}_{1}^{2}}{{J}_{A b}} ) \cdot {M}_{A b} - {M}_{S K2} \cdot ( 1 - \frac{{i}_{1}}{{i}_{2}} ) ] \qquad ( 2 )$$

From equation (1), one can find the clutch torque M_{AK} (in the case of a slipping clutch), and from equation (2) the engine torque required to generate an output torque of a desired time profile M_{Ab}(t) if M_{SK2}(t) is prescribed as a given function of time.

In the simple case of FIG. 2, the rate of change of the clutch torque M_{AK} with the start-up clutch in a slipping condition can be calculated as the time derivative of equation (1).

$${\dot{M}}_{A K} = \frac{1}{{i}_{1}} [ {\dot{M}}_{A b} - {\dot{M}}_{S K2} ( 1 - \frac{{i}_{1}}{{i}_{2}} ) ]$$

Analogously, the rate of change of the engine torque M_{Mot} can be calculated from equation (2), if the start-up clutch is in locked engagement.

With the substitution

$${\ddot{ϕ}}_{A b} = \frac{{M}_{A b}}{{J}_{A b}}$$

one arrives at the equation

$${\dot{M}}_{M o t} = \frac{1}{{i}_{1}} \cdot [ {\dot{M}}_{A b} \cdot \frac{{J}_{M o t} \cdot {i}_{1}^{2} + {J}_{A b}}{{J}_{A b}} - {\dot{M}}_{S K2} \cdot ( 1 - \frac{{i}_{1}}{{i}_{2}} ) ]$$

The relationships expressed by equations (1) and (2) can be used for controlling a clutch, such as a power-shift clutch, to lower the output torque in a controlled manner.

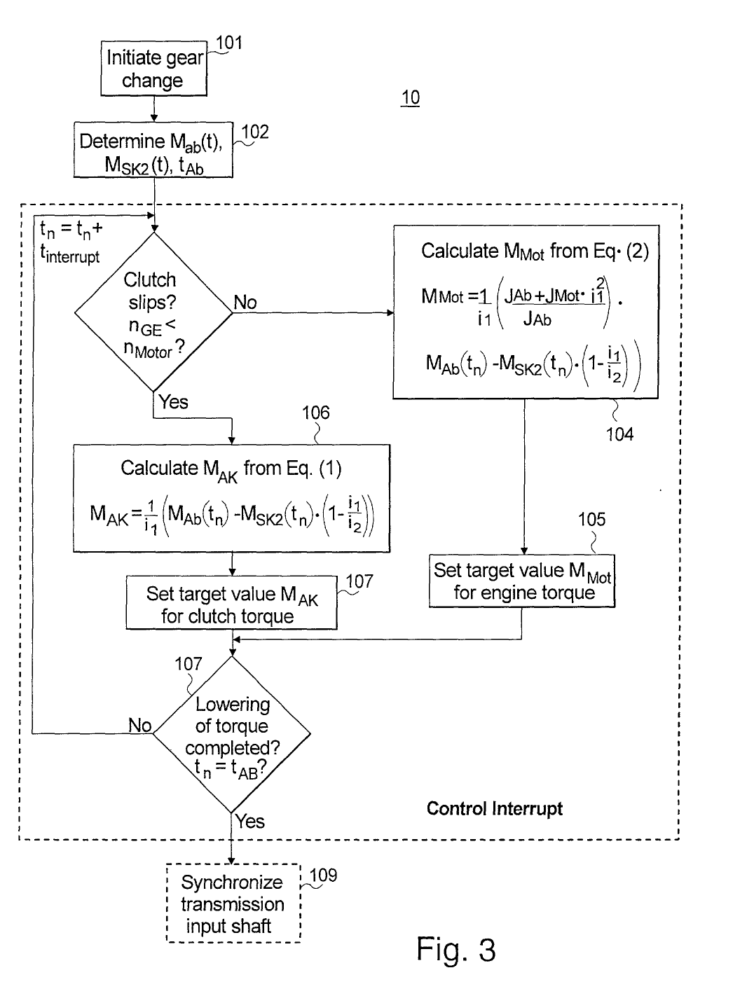

FIG. 3 illustrates a flowchart for the process of lowering the output torque. The amount of time t_{Ab} for the lowering of the output torque as well as the shape of the time profile M_{Ab}(t) can be prescribed to meet specified comfort requirements. However, embodiments of the invention are also conceivable in which t_{Ab} and M_{Ab}(t) are not prescribed. In the example of FIG. 3, a specific function M_{SK2}(t) is given for the build-up of the torque at the gear-shifting clutch SK2. Alternatively, the build-up of the torque can also be dependent on operating parameters. Subsequently, the control cycle runs through a clocked sequence with conditional branches that depend on whether the start-up clutch is in a slipping or locked condition and whether the target value of the clutch torque, and/or the engine torque or the target value for the engine torque is to be calculated.

It is further possible that the actual torque of the engine and the clutch follows the targeted torque with a time lag, for example according to a PT1-type of control behavior with a dead-time interval, which can be taken into account in the control program if desired.

In the flowchart 100 of FIG. 3, a gear change is initiated in block 101. The output torque M_{Ab}(t), the transmittable torque M_{SK2} of the shift clutch SK2, and the time interval tab are prescribed in block 102. The time interval tab substantially corresponds to the time t₃-t₁ in FIG. 2.

Block 103 represents an interrogation as to whether or not the clutch is in a slipping condition, i.e., whether the rpm-rate n_{GE} of the transmission input shaft is less than the engine rpm-rate nₘₒₜ. In the negative case of block 103, the program sequence continues in block 104, where a target value for the engine torque is calculated according to equation (2). Next, in block 105, the calculated value is set as the control target for the engine torque.

In the affirmative case of block 103, the transmittable torque of the start-up clutch AK is calculated in block 106 according to equation (1). In block 107, the calculated value M_{AK} is set as the control target for the clutch torque.

Block 108 represents an interrogation as to whether or not the lowering of the torque is completed, i.e., whether the elapsed time tₙ exceeds the prescribed time interval tab. In the affirmative case of block 108, the gear-changing process continues in block 109. In the negative case, the program loops back to block 103 and goes through another cycle.

It is advantageous if the transmission output receives a certain amount of torque through the engagement of the gear-shifting clutch (such as, e.g., a conical clutch) of the new gear while at the same time the actual rpm adaptation in the transmission is performed, e.g., by a partial disengagement of the start-up clutch or main clutch between the engine and the transmission.

It is advantageous if the amount of frictional energy generated in the conical clutch in the course of the entire gear-changing process is kept as small as possible to prevent the clutch from wearing out prematurely. On the other hand, the frictional torques acting in the clutches (cone clutch, main clutch) need to be properly adapted to each other in order to prevent discontinuities or abrupt torque changes detrimental to the driving comfort during the entire the gear-changing process.

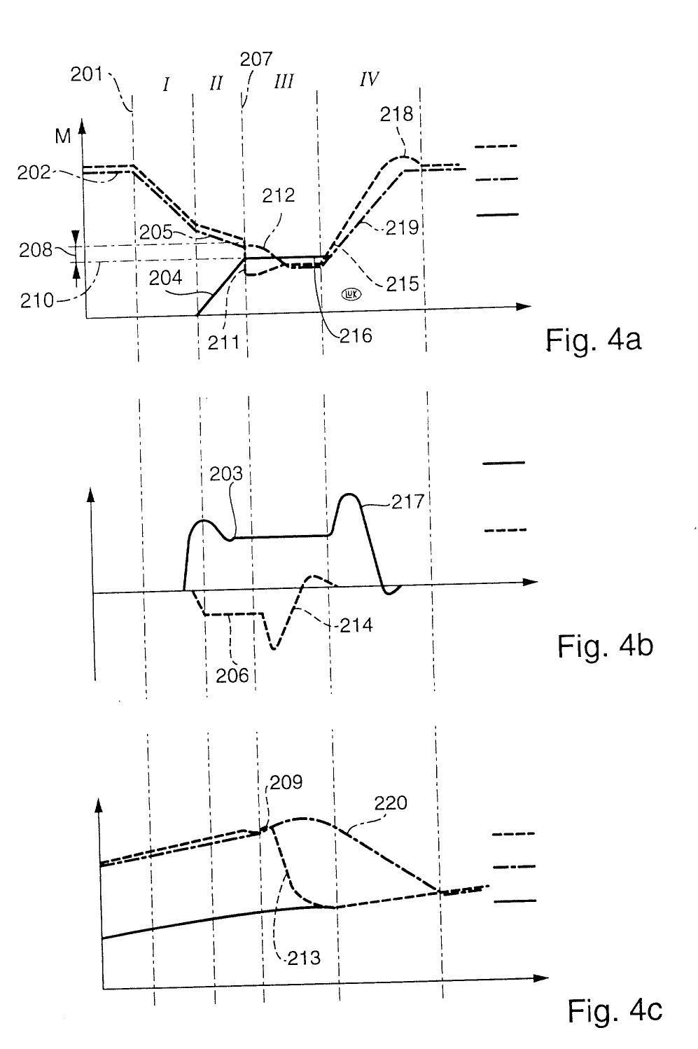

An example of the gear-changing process involving a coordinated simultaneous actuation of the transmission and clutch as well as assistance by the engine is illustrated in FIGS. 4a to 4c which include time graphs of the associated rpm-rates of the engine and the transmission.

The gear-changing process is divided into four phases I, II, III and IV. The process is started by an initiating signal 201 indicating a desire of the driver to change gears through the tipping of a lever, or a kick-down pedal action, or some other signal, or an automatic gear-shifting program of the transmission control device.

In addition to determining the new gear into which the transmission is to be shifted, there are additional characteristic parameters of the impending gear-shift that need to be prescribed by the control unit such as the transitional torque to fill the traction gap, the rates of change of the torque values, or time parameters. The gear-changing process runs as follows:

Phase I: The engine torque and the transmittable torque of the clutch, normally the start-up clutch, are lowered simultaneously from their initial levels at 202. It is possible to perform this phase without clutch slippage by keeping the engine torque smaller than the transmittable clutch torque, or to perform the phase with slippage by keeping the engine torque larger than the transmittable clutch torque.

Phase II: While the engine torque and the clutch torque are being lowered, an actuating force is applied to the gear-shifting clutch of the new gear (e.g., a conical clutch) at 203. As a consequence, a slip-friction torque is built up at 204 in the conical clutch while the current gear is still positively engaged (i.e., in form-locking engagement).

In order to maintain continuity in the lowering of the torque that is felt by the driver, the rates of lowering the engine torque and the clutch torque are preferably adjusted (at 205) from their previous values that they had in phase I.

While the conical clutch of the new gear is pushed towards engagement, a biasing force directed towards the neutral position is applied (at 206) to the sliding sleeve of the old gear.

Phase III: The transition from phase II to phase III (at 207) occurs when the shift actuator of the old gear breaks free and starts moving under the applied biasing force as the torque of the dog clutch of the old gear falls below the biasing-force dependent disengagement threshold. The disengagement threshold depends on the geometry of the dog clutch and the amount of friction that has to be overcome in the actuator to set the actuation in motion.

As a rule, the amount of the input torque entering the transmission will not match the friction torque at the conical clutch of the new gear, as indicated by the torque differential 208 in FIG. 4a. Thus, the retraction from engagement of the old gear occurs while there is still a residual amount of torque being transferred through the dog clutch of the old gear. Therefore, a slight jump occurs in the output torque of the transmission, causing at least a slight amount of acceleration of the input shaft at the beginning of phase III, as indicated at 209 in FIG. 4c. It is advantageous if the biasing force is appropriately selected so that the driver will not notice any discomfort from the slight jump of the output torque.

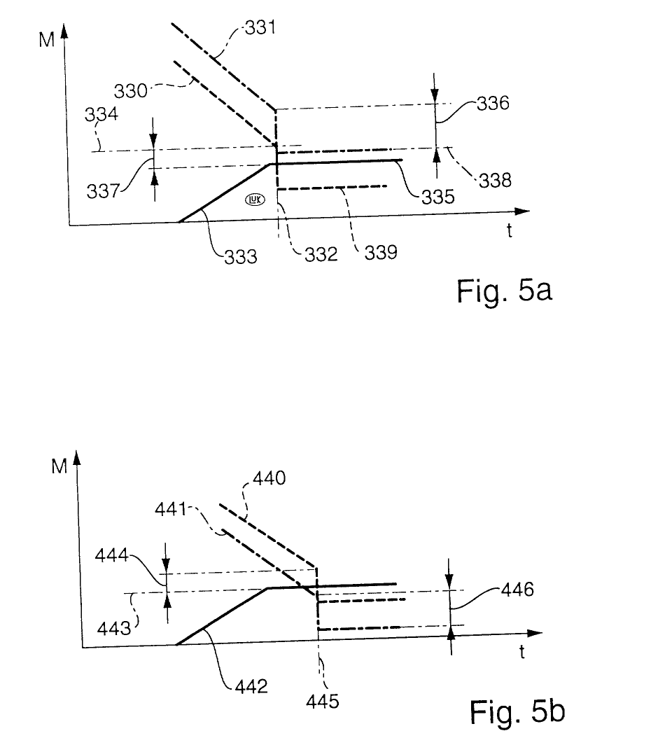

It is advantageous if the slip-friction torque in the conical clutch reaches the targeted level 210 of gap-filling torque simultaneously with the retraction from engagement of the old gear. If the old gear were disengaged earlier, in case the clutch torque is smaller than assumed (as will be discussed in the context of FIG. 5a), the gap-filling torque would come out smaller than intended. If the targeted amount of torque in the conical clutch is reached before the old gear has been taken out of engagement, one can continue to lower the transmission-input torque alone, i.e., the engine torque or the transmittable clutch torque, as will be discussed in the context of FIG. 5b.

Taking the old gear out of engagement at a specific level of residual torque, which may be calculated or estimated, is an essential feature in an example where the inventive solution is applied in practice. From the known residual torque in the gear-shifting clutch of the old gear, it is possible to determine the corresponding torque imbalance between the input torque of the transmission and the clutch torque in the gear-shifting clutch, such as a conical clutch, of the new gear.

After the transition from phase II to phase III has been found to be completed, the slip-friction torque of the main clutch is advantageously lowered to a lower amount than the slip-friction torque in the cone clutch of the new gear, as shown at 211 in FIG. 4a. This is a further feature of a practical application of the inventive method. FIG. 4a shows an abrupt change in the target value of the transmittable torque of the start-up clutch. The system response will occur in this case with a slight delay. The engine torque 212 at this time is larger than the transmittable clutch torque 211, so that the clutch is in a slipping condition and the large rotary mass of the engine is thereby uncoupled. Thus, only the synchronization of the transmission will take place at the beginning of phase III. The term “engine torque” in this context means the net torque after the inertial torque from accelerating or decelerating the rotary mass of the engine has been subtracted from the combustion-generated torque. In other words, the term engine torque is understood as the torque that is introduced into the clutch downstream of the flywheel. The shift actuator of the old gear is moved into its neutral position at 214. The end of phase III is characterized by the convergence of the rpm-rates for the new gear. In this transition from a slipping to a synchronized state, the torque introduced into the drive train jumps from the slip-friction torque of the gear-shifting clutch of the new gear to the slip-friction torque of the main clutch (at 215 in the time graph of FIG. 4a). Towards the end of the synchronization phase, the transmittable torque of the main clutch should therefore be raised (at 216) to an appropriate threshold level below the shift-clutch torque, so that the driver will not find the jump in the traction torque uncomfortable.

If the rpm-rate of the transmission input shaft does not fall off at 213 in the predetermined manner after the reduction of the clutch torque, the transmittable clutch torque can be reduced further. The further torque reduction can be carried out, e.g., under a back-up strategy.

It is also possible to keep the clutch torque at a constant level during the synchronization of the transmission, meaning that the target values for the clutch torque are the same at the beginning and end of phase III.

Phase IV: After the rpm-rates in the transmission have been matched, the dog clutch of the new gear is moved into engagement at 217, so that the cone clutch is no longer active. The start-up clutch or main clutch builds up its transmittable torque 218 at a faster rate than the engine torque 219, in order to match the rpm-rate 220 of the engine to the new rpm-rate of the transmission.

FIG. 5a illustrates a condition where the actual torque 330 transmitted through the main clutch is less than an assumed torque value 331. In this case, the biasing force of the shift actuator pulls the old gear out of engagement already at a time 332 when the build-up of the friction torque 333 in the conical clutch of the new gear has not yet reached the targeted level for the gap-filling torque 334.

It is a sound control strategy to hold the torque of the conical clutch at a constant level 335 from this point on and to decrease the engagement of the main clutch from its current level by a differential amount 336 that is larger than the residual torque 337 at the point of disengaging the old gear. In this case, it is not even necessary for the corrected absolute target amount 338 of the slip-friction torque of the main clutch to be smaller than the predetermined torque level 335 of the conical clutch. The torque 339 that is actually transmitted by the main clutch is lower by an amount corresponding to the size of the error, so that the input shaft of the transmission can be synchronized.

If the actual torque passing through the main clutch has an error in the opposite direction, i.e., if the actual torque 440 that is being transmitted through the main clutch is larger than the assumed torque 441, as shown in FIG. 5b, the old gear can not yet be retracted from engagement by the biasing force at the point where the torque 442 of the shift clutch or conical clutch reaches its target value 443. The lowering of the transmittable torque of the start-up clutch or main clutch needs to be continued at a slow rate of decrease until the disengagement threshold 444 has been reached in the dog clutch of the old gear and the latter can be taken out of engagement at the time 445. For the synchronization of the new gear, the control unit will again call for a decrease 446 from the then current magnitude of the main-clutch torque.

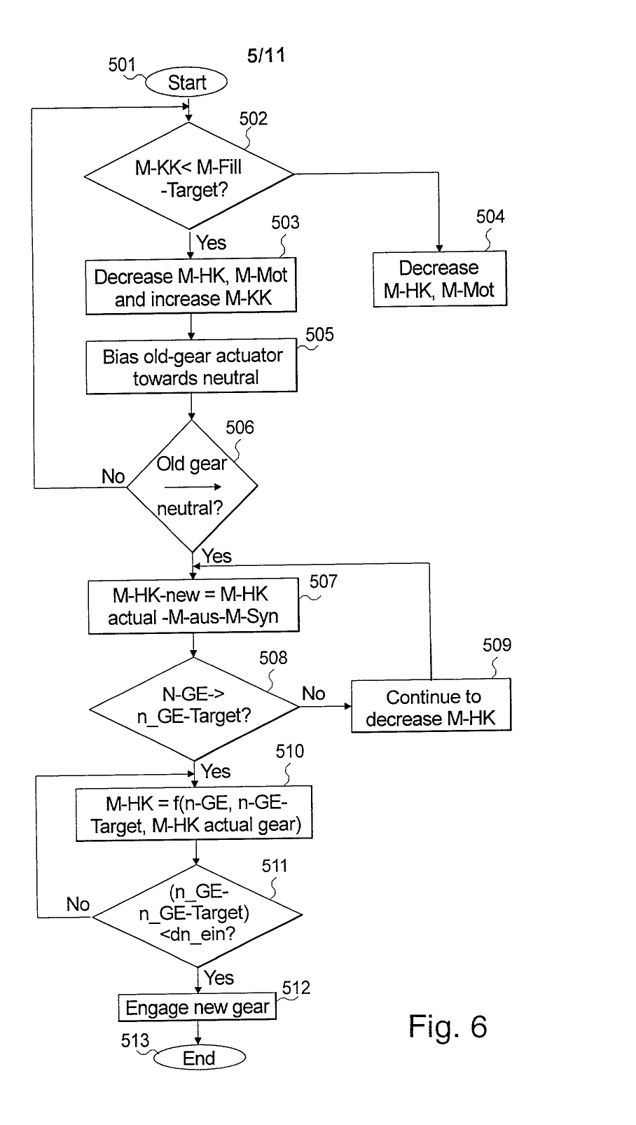

The shift process that has just been described is represented schematically in the flow chart 500 of FIG. 6.

The following symbols are used for the variables and parameters of the process:

M_{KK} Torque transmitted through the cone clutch of the new gear

M_{Full-Ziel} Targeted gap-filling torque at the shift clutch or cone clutch of the new gear

M_{HK} Slip-friction torque of the main clutch or start-up clutch

M_{Mot} Engine torque of the combustion engine

Mₐᵤₛ Drive-train torque at which the biasing force of the shift actuator takes the old gear out of engagement

M_{syn} Allowable torque differential between the main clutch and the cone- or shift clutch at the start of synchronization

n_{GE} Actual rpm-rate of the transmission input shaft

n_{GE-Ziel} Targeted rpm-rate of the transmission input shaft

Δnₑᵢₙ Allowable rpm-difference when shifting the new gear into engagement

The gear-shifting process is started in block 501. Block 502 represents an interrogation whether the torque M_{KK} transmitted through the shift clutch or cone clutch of the new gear is still smaller than the targeted gap-filling torque M_{Full-Ziel}. In the negative case of block 502, the program passes to block 504, where the control unit directs the engine torque Mₘₒₜ and/or the slip torque M_{HK} of the main clutch alone to be decreased. In the affirmative case of block 502, the program passes to block 503, where the control unit directs a decrease of the engine torque M_{Mot} and/or the slip torque M_{HK} of the main clutch in coordination with a further increase in the torque M_{KK} transmitted through the cone clutch of the new gear.

In block 505, the shift actuator of the old gear is energized to apply a biasing force in the direction towards the neutral position. In block 506, the old gear is pulled out of engagement, whereupon in block 507 the torque M_{HK} of the main clutch is immediately cut back by an amount that corresponds to the sum of the residual drive-train torque Mₐᵤₛ and the torque differential M_{syn} as defined above. The beginning of the synchronization can be detected from the rpm-rate n_{GE} of the input shaft by an interrogation in block 508 as to whether or not the actual rpm-rate n_{GE} of the transmission input shaft is changing towards the targeted rpm-rate n_{GE-Ziel}.

Block 510 represents the actual synchronization process in which the slip-friction torque of the main clutch as a function of time is controlled/regulated in accordance with a function that can be prescribed, e.g., dependent on the rpm-rates n_{GE}, n_{GE-Ziel}, the actual torque of the main clutch, or dependent on which gear is to be engaged as the new gear.

After the rpm-rates have been matched in block 511 within a tolerance range that can be prescribed, the new gear is shifted into engagement in block 512, and the shift process is completed in block 513.

Automated shift transmissions have power-shift clutches or shift clutches for shifting the gears of the transmission. These clutches can be configured, e.g., as friction clutches with flat or conical friction surfaces, or as synchronizer clutches. The synchronizer clutches can be designed for a higher power-transmitting capacity than conventional synchronizer clutches of manual shift transmissions in which traction is interrupted during gear shifts. The increased power-transmitting capacity makes the synchronizer clutches suitable for shifting a transmission under load.

However, differences between the torque of the main clutch and the torque of the synchronizer clutch will cause a rapid acceleration of the small inertial mass of the transmission input shaft, and the control of the synchronization process is therefore not easy to accomplish.

It is advantageous if a torque difference can be detected and a control strategy is carried out which allows a synchronization of the input shaft.

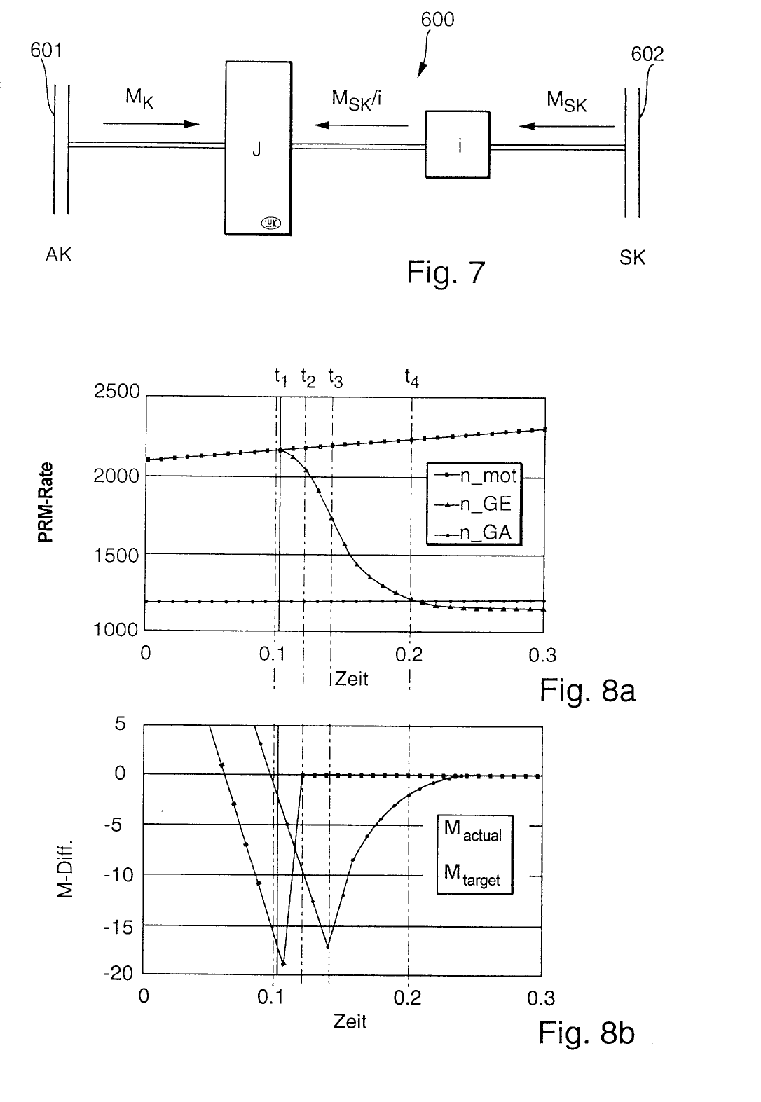

FIG. 7 illustrates the regulation of the torques M_{SK} Of the shift clutch 602 and M_{K} of the start-up clutch 601, which represents a key factor in the synchronization process. The two torques act in opposite directions and are coupled through a transmission-ratio factor. The torque differential M_{diff}=M_{K}−M_{SK}/i acts on the input inertia J, such as the mass moment of inertia of the transmission input shaft.

The absolute values of the respective torques transmitted through the shift clutch 602 and the start-up clutch 601 are unknown. The torque M_{K} of the start-up clutch can be adapted to the engine torque by means of a sensor-controlled adaptation or a torque regulation. Further information on these concepts may be found in DE 195 04 847, which is hereby incorporated by reference in the present disclosure.

In a case where the transmittable torque of the shift clutch is substantially constant, the rotation of the input mass J needs to be synchronized by varying the transmittable torque of the start-up clutch.

In a practical example of the inventive control strategy, it is essential to reduce the control target for the transmittable torque of the start-up clutch in a linear or otherwise defined manner. The actual torque will then follow the target at about the same rate of decrease, possibly delayed by the amount of an existing control lag.

It is also advantageous to observe the transmission input rpm-rate for detecting when a state of equilibrium has been attained between the torque of the start-up clutch and the torque of the shift clutch. In this regard, a distinction needs to be made between the following two cases:

1. The input rpm-rate of the transmission equals the engine rpm-rate at the time of reaching the torque equilibrium. This is the case if the clutch is not slipping during the lowering of the torque, or if at the disengagement of the old gear there is a positive torque differential that accelerates the input shaft back to the engine rpm-rate. The torque equilibrium will in this case be detected for example during the disengagement of the input shaft from the engine.

2. The input rpm-rate of the transmission is smaller than the engine rpm-rate. This situation occurs for example if the torque differential after the disengagement of the old gear is small or negative, or it occurs in the course of the synchronization. At the time of the torque equilibrium, the rpm-rate of the transmission input shaft will run through an extreme (maximum or minimum) which can be used to detect the equilibrium point. In this case, the control uses only the rpm-maximum that occurs at the time of the torque equilibrium after the old gear is retracted from engagement.

If the time of the equilibrium and the rpm-differential at that point in time are known and if a PT1 control behavior is assumed, it is possible to calculate a reversal point in the time profile of the rpm-rate—for example of the input shaft—where the clutch torque is regulated back to the equilibrium level. Because under the PT1-type of control, a discontinuous jump of the target torque causes an exponentially asymptotic response of the actual torque, it is possible to achieve a gentle, comfortable end point of the synchronization with a small torque difference.

Accordingly, the control of the synchronization occurs in four steps:

1. Reducing the clutch torque at a linear rate of change

2. Detecting and determining the point of torque equilibrium

3. Continuing the linear torque reduction to the calculated point of reversal

4. Regulating the clutch torque back to the equilibrium level

A parameter that can be adapted in the control process is the rate of change (time gradient) of the linear reduction of the torque. A small time gradient facilitates detection of the equilibrium state, but prolongs the time for reaching the equilibrium and thereby creates a load on the synchronizer elements of the transmission. If the time gradient is too large, there is a risk that the reversal point may be reached before a detection is even possible.

FIGS. 8a and 8b illustrate the time profile of the engine rpm-rate nₘₒₜ, of the transmission input rpm-rate n_{GE}, the transmission output rpm-rate n_{GA}, as well as the relative or differential values M_{diff} of the targeted torque and the actual torque. The diagrams represent only the case where the equilibrium is detected from the disengagement of the input shaft from the motor. Only the torque of the start-up clutch is being varied, while the synchronizer clutch transmits a constant level of torque. Thus, one only has to be concerned with the torque differential M_{diff} between the start-up clutch and the synchronizer clutch. The diagrams represent the synchronization in a shift from first to second gear.

The curves in FIG. 8b show respective minima for the actual value and the target value of the torque difference. This corresponds to an inflection point of the rpm-curve of the transmission input shaft.

In automated shift transmissions, particularly in those with independently shiftable gear-shifting clutches, the differences between the synchronization torque M_{SK} or M_{SK}/i and the main clutch torque M_{K} can cause fast rpm-changes of the input shaft. This creates a difficult technical challenge in controlling the synchronization of the input shaft.

In view of this problem, it can be advantageous to use the transmission input rpm-rate for adjusting the clutch torque M_{K} and the synchronization torque M_{SK}, i.e., for detecting a difference between the two as an input into the control process.

For a controlled or regulated shift process, it is advantageous to know the torque M_{SK} of the new gear to be engaged in relation to the torque M_{K} of the start-up clutch.

An embodiment of a control strategy according to the invention is based on the dynamic behavior of model for the relevant system masses and uses the differential equations of the model to calculate a torque difference. From the rotary acceleration of the transmission input shaft, one can calculate the torque acting on the input shaft which, on the other hand, equals exactly the difference between the clutch torque M_{K} and the synchronizer torque M_{SK}/i downstream of the gear stage. FIG. 7 gives a schematic representation of the model used for the transmission with one gear-shifting clutch and one start-up clutch. For simplicity, the schematic illustration shows only one gear-shifting clutch of the transmission. Of course, an actual transmission has a plurality of gear-shifting clutches for shifting the individual gears. The simplified model contains only the inertial rotary mass of the transmission input and the two clutches as well as one gear stage.

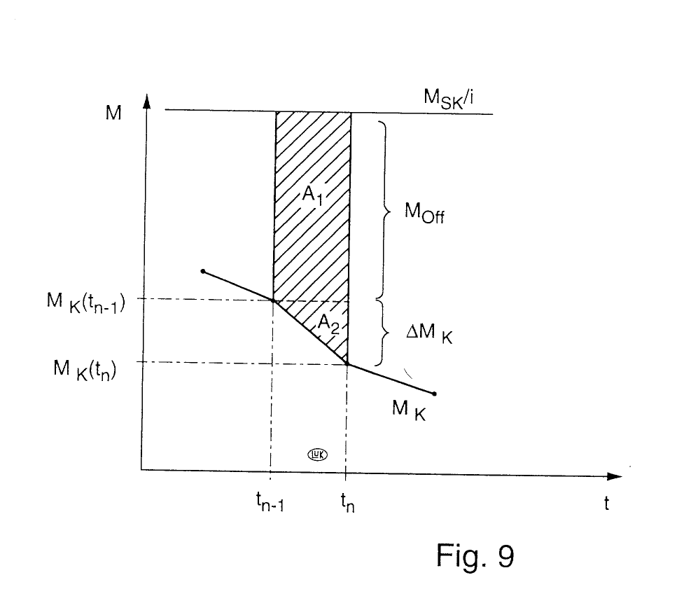

As the control of the synchronization process occurs within a time window, a so-called interrupt, the time integration is performed within the given interrupt-time interval At. FIG. 9 shows the time graph of a transmittable torque M_{K} of the start-up clutch. The notations used in the following equations are shown in the graph. M_{K}(tₙ) and M_{K}(tₙ₋₁) represent the values of the torque at the times tₙ and tₙ₋₁. J represents the mass moment of inertia associated with the transmission input shaft. The torque difference is represented by the symbol ΔM_{K}.

The model is represented by the following equations:

$$\int M ( t ) ⅆ t = {A}_{1} + {A}_{2} = J \cdot Δ n , \text{wherein} Δ n = {n}_{ti} ( {t}_{n - 1} ) - {n}_{ti} ( {t}_{n} )$$

$$\int M ( t ) ⅆ t = ( {M}_{Off} + \frac{1}{2} Δ {M}_{K} \cdot Δ t = J \cdot Δ n , wherein Δ {M}_{K} = {M}_{K} ( {t}_{n - 1} ) - {M}_{K} ( {t}_{n} )$$

wherein Δn=nₜ₁(tₙ₋₁)−nₜ₁(tₙ)

wherein ΔM_{K}=M_{K}(tₙ₋₁)−M_{K}(tₙ)

from which it follows that

$${M}_{Off} = \frac{J \cdot Δ n}{Δ t} - \frac{1}{2} Δ {M}_{K} \\ a n d \\ {M}_{S K} ( {t}_{n} ) / i = {M}_{K} ( {t}_{n} ) + \frac{J \cdot Δ n}{Δ t} + \frac{1}{2} Δ {M}_{K} \qquad ( 3 )$$

The equilibrium between the torques is detected by monitoring the input shaft rpm-rate as described above. After the old gear has been taken out of engagement, the transmission can be emulated by the model described above and the shift-clutch torque M_{SK} can thus be determined. Based on the torque difference, an appropriate control- or regulation response can take place. As an example of an elementary solution, a PID controller could be employed in which the rpm-difference of the shift clutch is used as input signal and a torque ΔM_{PID} corresponding to the torque difference is delivered as output signal. Thus, the clutch torque is governed by the equation M_{K}=M_{SK}/i−ΔM_{PID}.

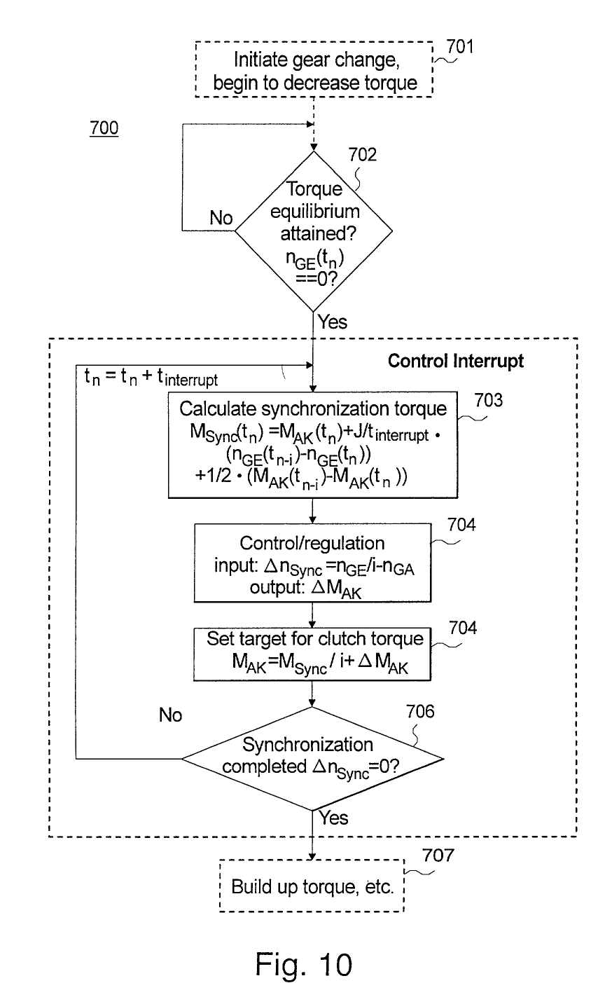

FIG. 10 shows a flowchart 700 of the process performed by the model. The gear change is initiated and the lowering of the torque begins in block 701. Block 702 represents an interrogation as to whether equilibrium has been attained between the torque M_{K} and the torque M_{SK}, i.e., whether the rate of rpm-change of the transmission input shaft dn_{GE}/dt=0. As long as the result in block 702 is negative, the interrogation is repeated. If the result is affirmative, the program proceeds to block 703 where the synchronization torque is calculated according to equation (3). In block 704, the rpm-difference is entered into the regulation or control algorithm, and a torque difference is obtained as a result. In block 705, the target torque M_{K} of the start-up clutch is determined and set as an actuator-control target. In block 706, an interrogation is made as to whether or not synchronization has been achieved, i.e., whether Δnsync=n_{GE}/i−n_{GA}=0. In the affirmative case, the shift process continues in block 707. In the negative case, the program loops back to block 703.

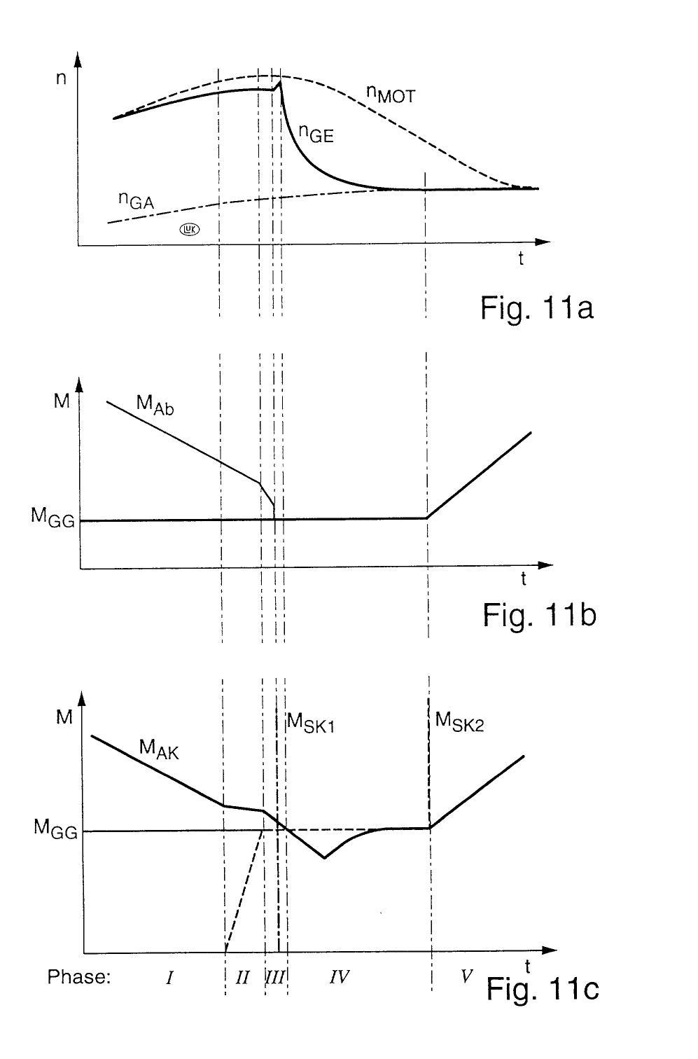

According to the invention, a gear change in a power-shift transmission can be subdivided into several phases as shown in FIGS. 11a to 11c, where the time profiles of an up-shift under traction are illustrated. The torque diagrams are shown as sequences of linear segments in order to give a better overview of the process. In principle, other curve shapes are also conceivable. For schematic simplification, a transmission ratio of i=1 was assumed. The full engagement of a gear is expressed in the drawing through an infinitely large slip-friction torque in the synchronizer clutch, which represents the model equivalent of a form-locked condition of the respective gear.

The time graphs in FIG. 11a represent the rpm-rate n_{GE} of the transmission input shaft, n_{GA} of the transmission output shaft, and nₘₒₜ of the engine. FIG. 11b illustrates the output torque M_{Ab} at the output of the transmission. FIG. 11c illustrates the respective transmittable torques M_{AK}, M_{SK1}, and M_{SK2} of the start-up clutch, the shift clutch 1 and the shift clutch 2 as a function of time.

The gear-change process begins in Phase I, where the output torque M_{Ab} is lowered in accordance with a time profile M_{Ab}(t) which determines the comfort characteristics of the shift process. The lowering of the output torque is achieved by lowering the engine torque and/or the clutch torque. In the example of FIGS. 11a to 11c, the lowering of the torque is accomplished by controlling the clutch slippage.

In Phase II, the synchronization torque M_{SK2} of the new gear is built up while the old gear is still engaged. Based on the effect that the synchronization torque has on the output torque, the engine torque or the clutch torque can be adjusted if necessary.

In Phase III, the transmittable torque of the start-up clutch is lowered further up to the point where the old gear, already pre-biased by an actuating force, can be pulled out of engagement at a point that depends on the applied force in relation to the difference between the clutch torque M_{AK} and the synchronizer torque M_{SK2}. After disengaging the old gear, the output torque M_{Ab} is determined only by the torque M_{SK2} of the synchronizer clutch of the new gear. If there is a difference between the main clutch torque and the synchronizer clutch torque, there will be a jump in the output torque. Furthermore, the transmission input shaft will be accelerated by the torque difference, i.e., n_{GE} increases, so that n_{GE} can as a maximum rise up to nₘₒₜ. Subsequently, the clutch torque M_{AK} is lowered further until the equilibrium torque level M_{GG} between the clutch torque M_{AK} and synchronizer torque M_{SK2} is attained.

In Phase IV, the transmission input shaft is synchronized by controlling or regulating the clutch torque M_{AK}. This phase is completed when the synchronizer clutch reaches the state of adhesive (non-slipping) friction so that the gear can be moved into full engagement.

In Phase V, the output torque is built up and the engine rpm-rate is slowed down to match the transmission input rpm-rate. The Phase V shown in FIGS. 11b and 11c illustrates the torque build-up in an automated shift transmission.

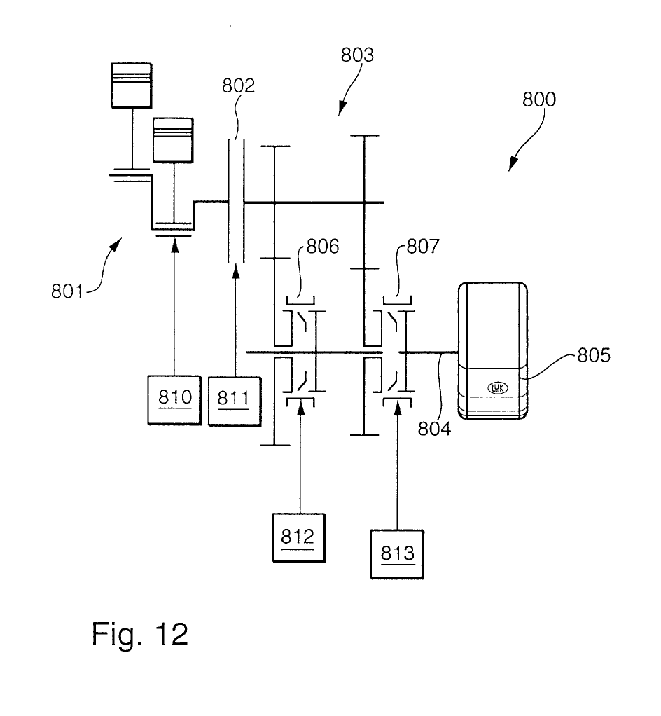

FIG. 12 schematically illustrates a power train arrangement 800 with a transmission 803 according to the invention, an engine 801, a start-up clutch 802, and an output section 804 of the drive train with a driven wheel 805. The engine 801 is controllable by means of an engine control 810, whereby the engine rpm-rate and/or the engine torque can be controlled. The start-up clutch 802 is equipped for automated actuation by means of an actuator 811. The transmission is shown as a schematically simplified example with two shift clutches 806 and 807 equipped for automated actuation by means of actuators 812 and 813, respectively, to change gears in the transmission 803. In actuality, the transmission may have more than two gear ratios and more than the two shift clutches 806, 807.

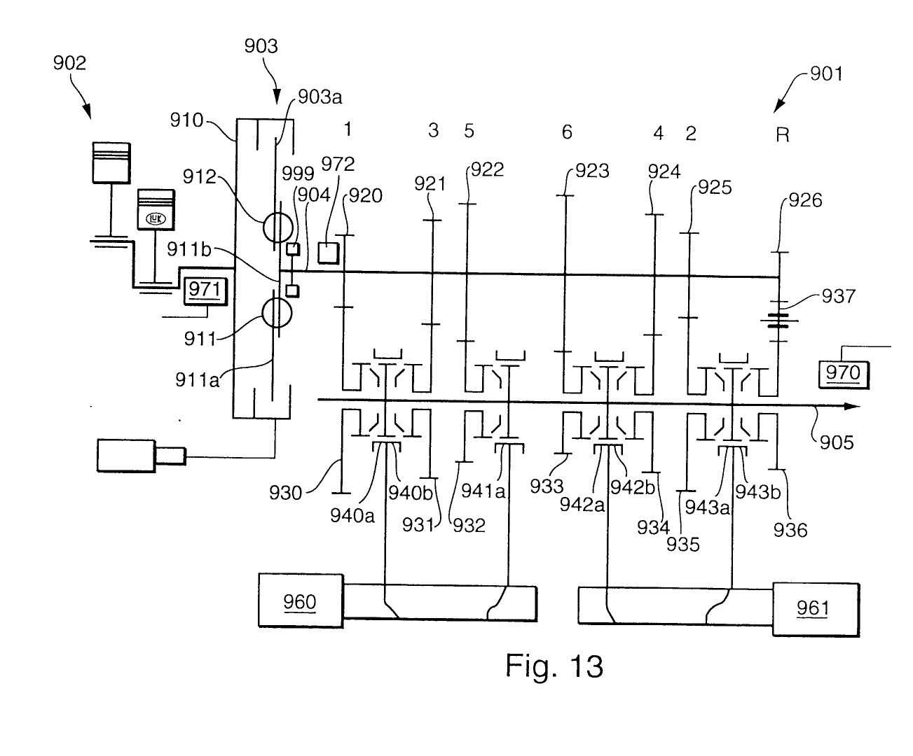

FIG. 13 schematically illustrates a motor vehicle transmission 901 arranged downstream of a drive source 902 such as a combustion engine and a start-up clutch 903 such as a friction clutch. The transmission 901 has an input shaft 904, a countershaft 905, and in some cases an additional output shaft. In the example of FIG. 13, the countershaft is identical with the output shaft. In another embodiment of the invention it is advantageous to provide an output shaft as a separate shaft in addition to the input shaft 904 and the countershaft 905.

A flywheel 910 is interposed between the engine 902 and the transmission 901. A friction clutch 903 with a pressure plate and a clutch cover is arranged on the downstream side of the flywheel 910. In place of the rigid flywheel 910, it is also possible to use a dual-mass flywheel with two inertial masses that are rotatable in relation to each other against the position-restoring forces generated, e.g., by energy-storing devices between the inertial masses.

A rotary oscillation damper 911 is arranged between the clutch disc 903a and the transmission input shaft 904. The oscillation damper has at least two disc-shaped components 911a, 911b that are rotatable relative to each other against the position-restoring forces generated, e.g., by energy-storing devices 912 that are arranged between the disc-shaped components. Preferably, the radially outer portions of the clutch disc have friction linings.

The shafts such as the input shaft, output shaft and in some cases the counter shaft are rotatably supported and radially centered as well as axially restrained in a transmission housing by means of bearings. These bearings are not explicitly shown in the drawing.

The input shaft 904 and the output shaft 905 are arranged in substantially parallel alignment to each other. In another embodiment, the arrangement of the output shaft can also be coaxial with the input shaft, with both shafts supported and centered in bearings in the transmission housing.

In an advantageous embodiment, the start-up clutch is arranged, e.g., as a wet-running friction clutch inside the transmission housing. In another advantageous embodiment, the clutch 903 is arranged, e.g., as a dry-running friction clutch inside a bell housing between the engine 902 and the transmission 901.

The fixed gear wheels 920, 921, 922, 923, 924, 925 and 926 are rotationally as well as axially fixed on the input shaft 904 of the transmission 901. The fixed gear wheels 920 to 926 mesh with respective counterparts 930, 931, 932, 933, 934, 935 and 936, e.g., free gear wheels that are rotatable freely on the countershaft 905 and can be brought into rotationally fixed connection with the countershaft 905 by means of clutches. The reverse idler gear 937 is arranged between the gear wheels 926 and 936, for the reverse-gear stage. Thus, the gear pair 926, 936 with the interposed reverse idler gear 937 represents the reverse mode of the transmission. The gear pair 920, 930 represents level 1, pair 925, 935 represents level 2, pair 921, 931 represents level 3, pair 924, 934 represents level 4, pair 922, 932 represents level 5, and pair 923, 933 represents level 6 of the transmission. In another advantageous embodiment, the free gear wheels 930 to 936 can be arranged on the transmission input shaft and the fixed gears on the countershaft. In a further embodiment, each of the shafts can carry free as well as fixed gear wheels.

Either of the gear wheels 930, 931 can be brought into form-locking connection with the countershaft 905 through an axial displacement of the clutches 940a, 940b, which may be configured as a sliding sleeve, synchronizer clutch, power-shift clutch, or friction cone. Analogously, the gear wheel 932 can be locked to the countershaft 905 by pushing the sliding sleeve 941a in the axial direction. Either of the gear wheels 933, 934 can be brought into form-locking connection with the countershaft 905 through an axial displacement of the sliding sleeve 942a, 942b. In like manner, either of the gear wheels 935, 936 can be brought into form-locking connection with the countershaft 905 through an axial displacement of the sliding sleeve 943a, 943b. It is preferred if the different free gear wheels can be coupled to the countershaft independently of each other in an arrangement where all of the aforementioned clutches 940a to 943b can be actuated independently of each other.

It is advantageous if the clutches 940, 941 and/or 942 are configured as friction-based clutches. In a further embodiment, the clutches 940, 941 and/or 942 can be configured as friction-based clutches with conical or plane ring-shaped friction surfaces, either with one or more than one friction surface, such as a multi-disc clutch. The clutches can furthermore be configured with a synchronization device that includes one or more than one synchronizer ring 950.

The clutches 940a to 943b are actuated, i.e., moved in the axial direction, by the actuator units 960, 961. Each clutch is connected to one of the actuator units, e.g., by a rod mechanism, a hydrostatic transfer connection, a pull-rope, a Bowden cable, or a shifter shaft. The actuator units can be driven by an electric motor, an electromagnet, and/or a pressure-operated device such as a hydraulic unit. Detailed information on this aspect may be found in DE 44 26 260, DE 195 04 847, DE 196 27 980, and DE 196 37 001. The present invention is related to the aforementioned earlier patent applications, which are expressly incorporated herein by reference.

An rpm-sensor 970 serves to detect the transmission output rpm-rate, i.e., the rpm-rate of shaft 905. An additional rpm-sensor 972 may be provided for the detection of the transmission input rpm-rate, i.e., the rpm-rate of shaft 904. An rpm-sensor 971 serves to detect the engine rpm-rate. An electronic control unit with memory and processing capability receives the sensor signals and generates control signals for the actuator units to operate the start-up clutch and the gear-shifting clutches of the transmission. The rpm-rates of the shafts can also be calculated from rpm-measurements of other shafts by taking the applicable transmission ratio into account.

The start-up clutch 903 can be operated by means of an actuator.

As a further advantageous feature of the inventive transmission, the shaft 904 can be driven by an electro-mechanical energy converter such as a starter motor, generator, or starter/generator by way of one of the gear wheels of the transmission such as 920 or 926. It is likewise possible for the shaft 904 to drive an electric generator such as an alternator. It is particularly advantageous if the starter motor and the generator are combined into an electro-mechanical energy converter such as a starter/generator. The electro-mechanical energy converter can start the combustion engine, but it can also work in a further operating mode to supply torque to the output side of the transmission and thereby assist the vehicle engine in propelling the vehicle. For situations requiring only moderate amounts of torque or power, the electro-mechanical energy converter can also be appropriately configured to be operable as the sole drive source of the vehicle at least for short time intervals. In a further embodiment or a further practical application of the invention, the electro-mechanical energy converter can be used to convert a portion of the kinetic energy of the vehicle into electrical energy, e.g., for storage in a battery. The latter mode of operation can be activated, e.g., when the engine 902 works in an engine-brake mode, for example when traveling downhill and/or to decelerate the vehicle. In a vehicle with a transmission according to the invention, this represents an advantageous possibility for lowering fuel consumption as well as reducing the emission of pollutants. As yet another possibility, the electro-mechanical energy converter can be used to raise a torque level in the transmission during gear changes.

To summarize, the inventive method relates to the operation of a transmission 901 that performs gear changes under a torque load or is capable of performing gear changes under a torque load.

In a wider sense, the system that is operated by the inventive method also encompasses an electronic control unit with microprocessor(s) to control the transmission and the clutches electronically, an rpm-sensor arrangement, an electronic throttle valve control or engine intake control, an electronic control for the combustion engine, a manually operable gear-selector element such as a lever, switch or the like to select gears in a manual and/or automated mode, and an indicator inside the vehicle compartment to indicate which gear is engaged in the transmission.

The shift process is initiated, e.g., when the driver signals a desire to shift, or when the automatic control unit determines that there is a need to change gears.

The invention is further related to a transmission that meets the foregoing description and is further equipped with an add-on mass such as, e.g., a mass ring that is connected to the transmission input shaft in order to increase the mass moment of inertia at the input side of the transmission. It is advantageous if the add-on mass is connected to the transmission input shaft or to an element that is connected to the input shaft such as, e.g., a clutch disc or the like. According to the invention, the add-on mass is an advantageous feature because it lessens the burst of the rpm-rate which would occur without the add-on mass when a torque is applied to the input shaft during a synchronization phase. The add-on mass can be configured, e.g., as a metal ring made, e.g., of sheet metal and connected to the transmission input shaft 904. The add-on mass is most effective if its diameter is as large as possible.

It is further proposed within the realm of the present invention to provide an electro-mechanical energy converter in connection with a transmission of the foregoing description. The rotor of the electro-mechanical energy converter would either by itself constitute a flywheel mass or be connected to a freely rotatable flywheel mass which could advantageously be separable from the engine and from the drive train or transmission to make use of the kinetic momentum, so that a hybrid drive could be realized with this arrangement.

Under the foregoing concept, the transmission allows a comprehensive utilization of the electro-mechanical energy converter, e.g., as a starter motor for the combustion engine, as an electricity generator, as a supplemental drive source for the vehicle, as a sole drive source, and also as an energy recovery device to extract kinetic energy from the traveling momentum of the vehicle and convert it into electrical energy or into rotary kinetic energy using the rotor mass of the electro-mechanical energy converter as a flywheel during deceleration phases of the vehicle while the combustion engine is uncoupled from the drive train.

If an electro-mechanical energy converter is coupled to the transmission as proposed under the present invention, the add-on mass can be constituted by a part of the electro-mechanical energy converter.

Without further analysis, the foregoing will so fully reveal the essence of the present invention that others can, by applying current knowledge, readily adapt it for various applications without omitting features that, from the standpoint of prior art, fairly constitute essential characteristics of the generic and specific aspects of the aforedescribed contribution to the art and, therefore, such adaptations should and are intended to be comprehended within the meaning and range of equivalence of the appended claims.

What is claimed is:

1. A method of controlling a ratio change from an old ratio to a new ratio in a transmission, wherein the transmission comprises:
a start-up clutch passing a transmittable start-up clutch torque from an engine generating an engine torque to an input side of the transmission,
a plurality of fixed gears, and
a plurality of free gears that are engageable and disengageable by a corresponding plurality of gear-shifting clutches in order to effect said ratio change, wherein among said gear-shifting clutches, an old gear-shifting clutch is engaged while the transmission is at the old ratio and a new gear-shifting clutch is engaged when the transmission is at the new ratio;
wherein said method comprises controlling an output torque of the transmission through the steps of:
controlling at least one of the engine torque and the transmittable start-up clutch torque, and
controlling a transmittable shifting-clutch torque of at least one of said gear-shifting clutches.

2. The method of claim 1, wherein controlling the output torque of the transmission comprises lowering said output torque, and wherein said old gear-shifting clutch is kept engaged until the output torque has been lowered to a predetermined level.

3. The method of claim 1, wherein the step of controlling the transmittable shifting-clutch torque is performed on a gear-shifting clutch other than said old gear-shifting clutch.

4. The method of claim 3, wherein the step of controlling the transmittable shifting-clutch torque is performed in accordance with a known, given time profile of said transmittable shifting-clutch torque, and wherein the step of controlling at least one of the engine torque and the transmittable start-up clutch torque is performed so as to effect one of a targeted increase and a targeted decrease of the output torque.

5. The method of claim 3, wherein said other gear-shifting clutch is the same as the new gear-shifting clutch.

6. The method of claim 3, wherein said other gear-shifting clutch is not the same as the new gear-shifting clutch.

7. A method of controlling a ratio change from an old ratio to a new ratio in a transmission, wherein the transmission comprises:
a start-up clutch passing a transmittable start-up clutch torque from an engine generating an engine torque to an input side of the transmission,
a plurality of fixed gears, and
a plurality of free gears that are engageable and disengageable by a corresponding plurality of gear-shifting clutches in order to effect said ratio change, wherein among said gear-shifting clutches, an old gear-shifting clutch is engaged while the transmission is at the old ratio and a new gear-shifting clutch is engaged when the transmission is at the new ratio;
wherein the engine torque is controllable by means of a control device and an actuator, and the start-up clutch and gear-shifting clutches are controllable by means of at least one further actuator;
said method being performed in four time phases and comprising the steps of:
in Phase 1, lowering the engine torque and lowering a transmittable start-up clutch torque;
in Phase 2, applying an actuating force towards engagement to the new gear-shifting clutch and an actuating force towards neutral to the old gear-shifting clutch by means of the at least one further actuator;
in Phase 3, taking the old gear-shifting clutch out of engagement when a predetermined residual torque level has been reached at the old gear-shifting clutch; and
in Phase 4, moving the new gear-shifting clutch into engagement.

8. The method of claim 7, further comprising the step of:
in Phase 4, raising the transmittable start-up clutch torque.

9. The method of claim 7, further comprising the step of:
in Phase 4, raising the engine torque.

10. The method of claim 7, further comprising the step of:
in Phase 4, raising the engine torque and raising the transmittable start-up clutch torque at a faster rate than the engine torque.

11. The method of claim 7, further comprising the step of:
in Phase 3, bringing the new gear-shifting clutch into a synchronized condition.

12. The method of claim 7, wherein the method steps of Phase 1 are performed with the start-up clutch in a non-slipping condition.

13. The method of claim 7, wherein the method steps of Phase 1 are performed with the start-up clutch in a slipping condition.

14. A method of controlling a ratio change from an old ratio to a new ratio in a transmission, wherein the transmission comprises:
a start-up clutch passing a transmittable start-up clutch torque from an engine generating an engine torque to a transmission input shaft,
a plurality of fixed gears, and
a plurality of free gears that are engageable and disengageable by a corresponding plurality of gear-shifting clutches in order to effect said ratio change, wherein among said gear-shifting clutches, an old gear-shifting clutch is engaged while the transmission is at the old ratio and a new gear-shifting clutch is engaged when the transmission is at the new ratio;
wherein the engine torque is controllable by means of a control device and an actuator, and the start-up clutch and gear-shifting clutches are controllable by means of at least one further actuator;
said method comprising the steps of:
determining an input rpm-rate of the transmission input shaft as well as an acceleration of said input rpm-rate, and
based on said acceleration, determining a torque difference between the transmittable start-up clutch torque and a transmittable shifting-clutch torque of the new gear-shifting clutch.

15. The method of claim 14, further comprising the step of determining the transmittable shifting-clutch torque of the new gear-shifting clutch based on said input rpm-rate and on the transmittable start-up clutch torque.

16. The method of claim 14, further comprising the steps of:
determining an output rpm-rate of the transmission output shaft, and based on the input rpm-rate and the output rpm-rate, determining an rpm-difference Δn_{SK} at the new gear-shifting clutch.

17. The method of claim 16, further comprising the step of determining a target value ΔM_{AK} for a change of the transmittable start-up clutch torque, wherein said target value ΔM_{AK} is a function of said rpm-difference Δn_{SK}.

18. The method of claim 17, further comprising the step of determining the transmittable start-up clutch torque M_{AK} through the equation M_{AK}=M_{SK}/i+ΔM_{AK}, wherein M_{SK} stands for the transmittable shifting-clutch torque of the new gear-shifting clutch and i stands for the new ratio.

19. A method of controlling a ratio change from an old ratio to a new ratio in a transmission, wherein the transmission comprises:
a start-up clutch passing a transmittable start-up clutch torque from an engine generating an engine torque to an input shaft of the transmission,
a plurality of fixed gears, and
a plurality of free gears that are engageable and disengageable by a corresponding plurality of gear-shifting clutches in order to effect said ratio change, wherein among said gear-shifting clutches, an old gear-shifting clutch is engaged while the transmission is at the old ratio and a new gear-shifting clutch is engaged when the transmission is at the new ratio;
wherein the engine torque is controllable by means of a control device and an actuator, and the start-up clutch and gear-shifting clutches are controllable by means of at least one further actuator;
said method comprising the steps of:
lowering the transmittable start-up clutch torque;
determining an equilibrium torque at which the transmittable start-up clutch torque will be equal to a transmittable torque of the new gear-shifting clutch;
monitoring an input rpm-rate of said input shaft and continuing to lower the transmittable start-up clutch torque until an inflection point is detected in said input rpm-rate; and
regulating the start-up clutch torque to match said equilibrium torque.

20. The method of claim 19, wherein the equilibrium torque comprises a torque value of one of the transmittable start-up clutch torque and the transmittable torque of the new gear-shifting clutch which occurs when said input rpm-rate as a function of time passes through one of a maximum and minimum.

21. The method of claim 20, wherein the presence of said one of a maximum and minimum is determined on the basis of a first derivative of said input rpm-rate as a function of time.

22. The method of claim 20, wherein the presence of said one of a maximum and minimum is determined on the basis of first difference values of said input rpm-rate over a succession of finite equal intervals of time.
